(19) United States
(12) Patent Application Publication
(10) Pub. No.: US 2012/0161488 A1
(43) Pub. Date: Jun. 28, 2012

(54) RECLINING APPARATUS

(75) Inventors: Yoshitaka ISHIHARA, Aichi (JP); Kazuyoshi HARA, Aichi (JP)

(73) Assignee: IMASEN ELECTRIC INDUSTRIAL CO., LTD., Aichi (JP)

(21) Appl. No.: 13/410,353

(22) Filed: Mar. 2, 2012

(30) Foreign Application Priority Data
Sep. 7, 2010 (JP) 2010-200131

(51) Int. Cl. B60N 2/235

(52) U.S. Cl. 297/367 R

(57) ABSTRACT

A reclining apparatus includes: a base plate on the first member; a gear plate on the second member and pivotably combined to the base plate; first and second guide portions on the base plate; first and second guide surfaces on the first guide portion; first and second guide surface on the second guide portion; first and second locking gear that are engageable with the gear plate; and a movable guide interposed between the first guide portion or the second guide portion and the first locking gear or the second locking gear. The first guide surface of the second guide portion faces the first locking gear. A recess is provided in the second guide surface of the first guide portion that orients the same pivotal direction as the first guide surface of the second guide portion to reduce a contact area with the second locking gear.

### CROSS-REFERENCE TO RELATED APPLICATION

This application is based on Japanese Patent Application No. 2010-200131 filed with the Japan Patent Office on Sep. 7, 2010, the entire content of which is hereby incorporated by reference.

### BACKGROUND

1. Technical Field

The embodiments disclosed herein relate to a reclining apparatus for adjusting the inclination between a first member and a second member.

2. Related Art

An exemplary reclining apparatus for adjusting the inclination between a first member and a second member is disclosed in JP-A-2009-39340. The reclining apparatus includes a plurality of movable guides. The movable guides are interposed between locking gears and fixed guides, respectively, in a slidable manner. The movable guide has a width gradually reducing from the outer end toward the inner end. The movable guide has a slide surface on the side of the locking gear and a slide surface on the side of the fixed guide. The locking gear side slide surface is provided in parallel with the direction of movement of the locking gear. Meanwhile, the fixed guide side slide surface is provided at an angle relative to the locking gear side slide surface. Further, springs are provided to the movable guides, respectively. Thus, the movable guides are biased by the springs toward the interior of a base plate.

The movable guide thus biased is jammed in between the locking gear and the fixed guide at all times. More specifically, the fixed guides, the locking gears, and the movable guides snugly fit one another. In other words, substantially no gap exists between the members. This configuration reliably eliminates instability of a seat back that may be caused by play between movable members in the fore-and aft direction. As a result, the reclining apparatus can be securely locked and unlocked.

### SUMMARY

An aspect of the present invention is a reclining apparatus for adjusting the inclination between a first member and a second member that are inclinable relative to each other. The reclining apparatus includes: a base plate attached to the first member; a gear plate attached to the second member and combined to the base plate in such a manner as to be pivotable relative to the base plate; a first guide portion and a second guide portion that are provided on the base plate; a first guide surface and a second guide surface that are provided on the first guide portion; a first guide surface and a second guide surface that are provided on the second guide portion; a first locking gear and a second locking gear that are engageable with the gear plate; and a movable guide interposed between the first guide portion or the second guide portion and the first locking gear or the second locking gear. The first guide surface of the second guide portion faces the first locking gear, and a recess is provided in the second guide surface of the first guide portion that orients the same pivotal direction as the first guide surface of the second guide portion to reduce the contact area with the second locking gear.

### BRIEF DESCRIPTION OF DRAWINGS

FIG. 1 is a side view of a schematic configuration of a vehicle seat mounted with a reclining apparatus according to an embodiment;

FIG. 2 is a cross-sectional view of the reclining apparatus;

FIG. 3 is a cross-sectional view taken along line 3-3 in FIG. 2;

FIG. 4 is a cross-sectional view taken along line 4-4 in FIG. 2;

FIG. 5 is a cross-sectional view taken long line 5-5 in FIG. 2;

FIG. 6 is an explanatory view depicting a positional relationship between locking gears and a cam lever in an unlocked state;

FIG. 7 is a cross-sectional view depicting a state of abutment of first locking gears on arcuate step portions in a lock-free state;

FIG. 8 is a cross-sectional view depicting the positions of second locking gears in a lock-free state; and

FIG. 9 is an explanatory view depicting a positional relationship between the locking gears and the cam lever in a locked state.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

To increase the number of locking gears, for example, for reducing loads to be imposed per locking gear, the number of movable guides is increased as well, so as to provide the locking gears and the movable guides by the same number. Increasing the number of the movable guides however entails increasing the number of components, e.g., springs, relating to the movable guides. It is thus conceivable to provide movable guides to a portion of the plurality of locking gears.

However, as described earlier, providing movable guides to a portion of the locking gears may bring about the following situation: when a great load due to, for example, an impact acts on the reclining apparatus, imbalance may occur in the load to act directly from the locking gears to the guide surfaces for guiding the locking gears with no movable guides interposed therebetween and the load to act from the locking gears to the guide surfaces with the movable guides interposed therebetween.

The present disclosure intends to provide a reclining apparatus that allows for suppression of imbalance in load to act on locking gears even in the case of employing movable guides for a portion of locking gears.

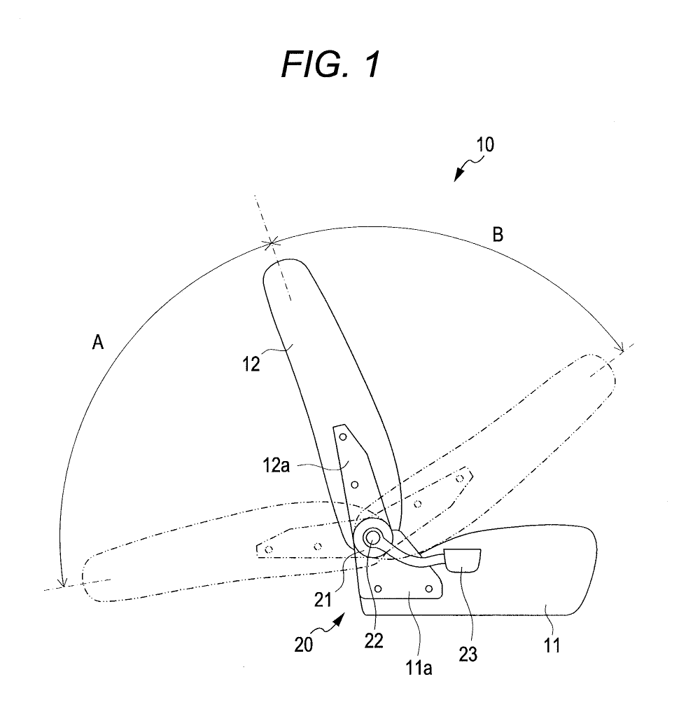

A reclining apparatus 20 according to an embodiment of the present disclosure is described with reference to the drawings. FIG. 1 is a side view of a schematic configuration of a vehicle seat 10 mounted with a reclining apparatus 20 of the present embodiment.

The vehicle seat 10 includes a seat cushion 11, a seat back 12, and the reclining apparatus 20. The reclining apparatus 20 is configured such that the inclination between a first member and a second member is adjustable. The first member includes the seat cushion 11 and a seat bracket (lower bracket) 11a. The second member includes the seat back 12 and a seat back bracket (upper bracket) 12a. The seat bracket (lower bracket) 11a is fixed to the seat cushion 11. The seat back bracket (upper bracket) 12a is fixed to the seat back 12.

As described above, the lower bracket 11a and the upper bracket 12a are fixed at two portions on the reclining apparatus 20 (round reclining unit 21), respectively, where the two portions are pivotable relative to each other. Hence, the lower bracket 11a and the upper bracket 12a are coupled to each other in a relatively pivotable manner. Thus, the inclination of the seat back 12 with respect to the seat cushion 11 is adjustable.

The reclining apparatus 20 includes the round reclining unit 21, a center shaft 22, and a reclining control lever 23. The reclining control lever 23 is fitted to the center shaft 22 disposed at the center of the round reclining unit 21. More specifically, the reclining control lever 23 and the center shaft 22 constitute a release member for bringing the reclining apparatus 20 into a locked or unlocked state. Raising the reclining control lever 23 causes the reclining apparatus 20 to be unlocked. Thus, the user can adjust the inclination of the seat back 12 by raising the reclining control lever 23. FIG. 1 shows an inclination range A in which the seat back 12 is inclinable toward the aft and an inclination range B in which the seat back 12 is inclinable toward the fore. When the user's hand and fingers leave the reclining control lever 23 within the inclination range A, the seat back 12 is set at the inclination at that moment. Meanwhile, in the inclination range B, even when the user's hand and fingers leave the reclining control lever 23, the reclining apparatus 20 remains unlocked. In other words, the seat back 12 is in a lock-free state and is thus pivotable. Accordingly, as depicted in FIG. 1, the seat back 12 is pivotable from a forwardly inclined position in contact with the seat cushion 11 to a backwardly inclined position in flush with the seat cushion 11. Description is given below of the structure of the reclining apparatus 20.

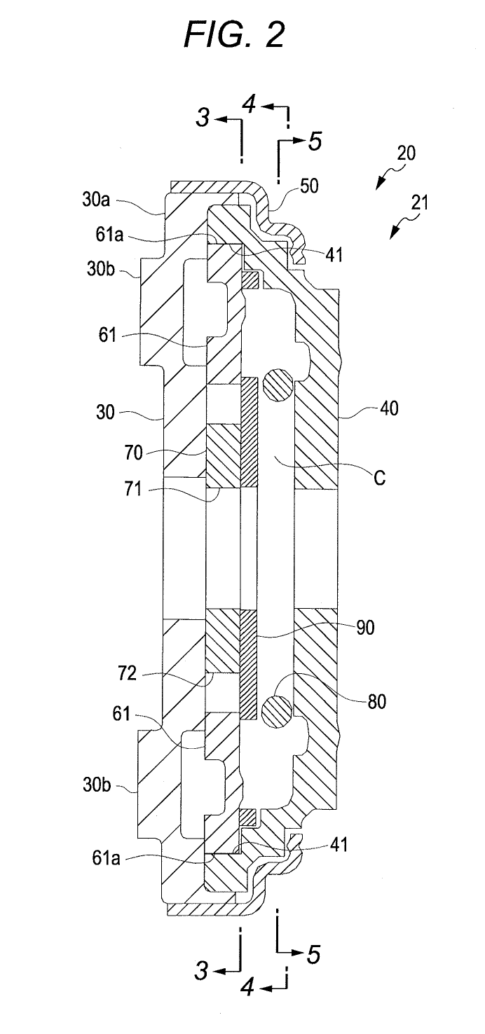

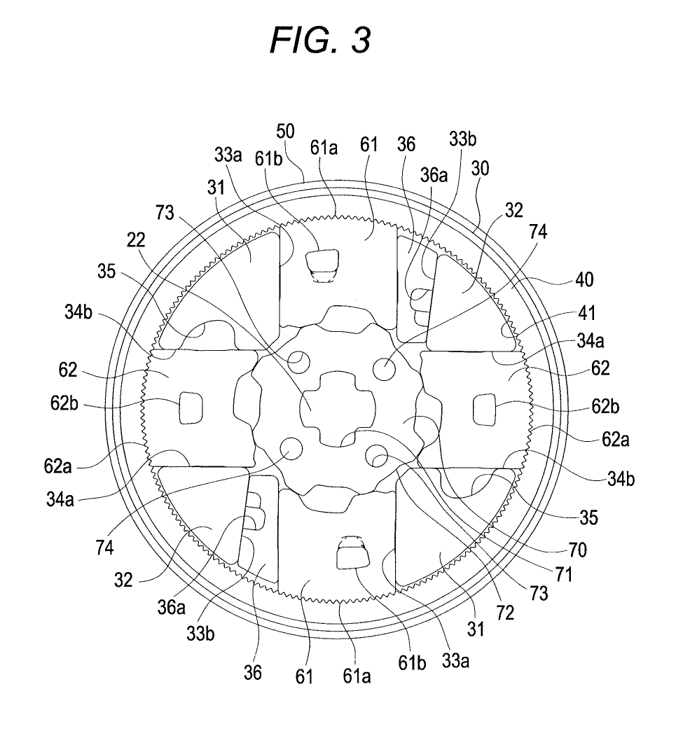

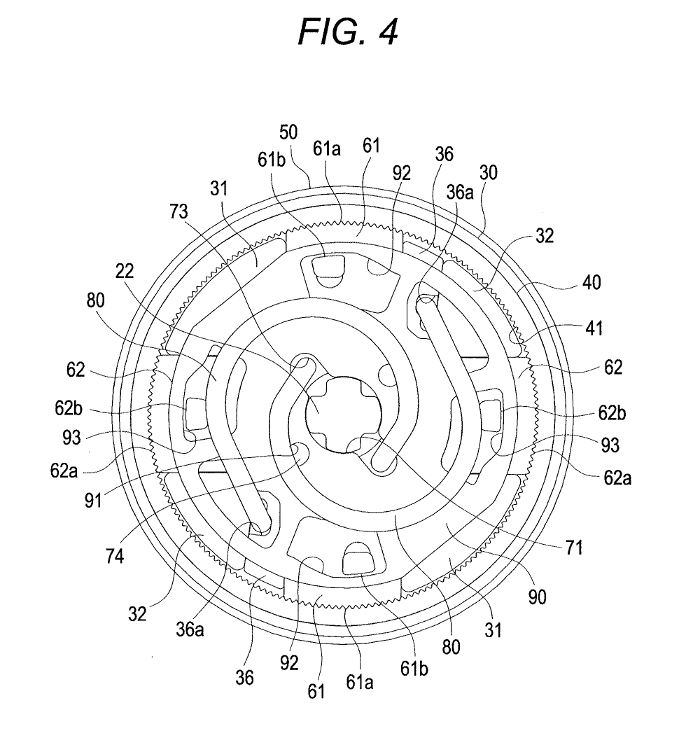

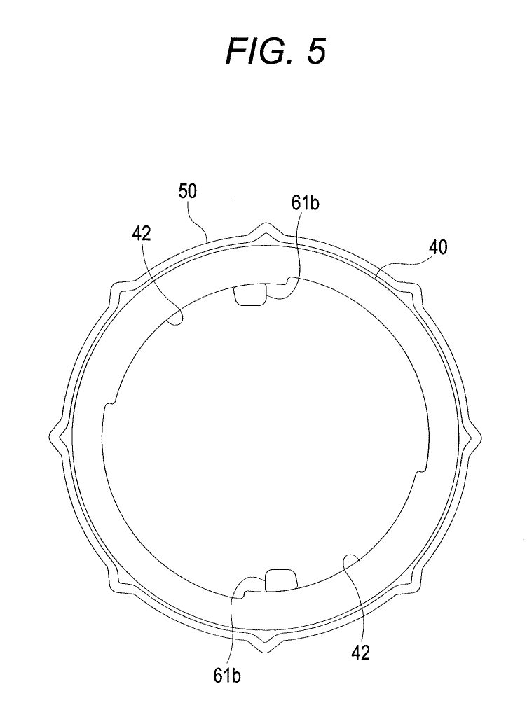

FIG. 2 is a cross-sectional view of the reclining apparatus 20. FIG. 3 is a cross-sectional view taken along line 3-3 in FIG. 2. FIG. 4 is a cross-sectional view taken along line 4-4 in FIG. 2. FIG. 5 is a cross-sectional view taken along line 5-5 in FIG. 2. In FIG. 2, the center shaft 22 and the reclining control lever 23 are not shown for easy understanding. In FIG. 4, portions other than the vicinity of internal gears 41 on a gear plate 40 are not shown. In FIG. 5, portions other than the vicinity of arcuate step portions 42 of the gear plate 40 are not shown.

As depicted in FIG. 2, the round reclining unit 21 includes a substantially disk-shaped base plate 30, the substantially cup-shaped gear plate 40, and a cover bracket 50. The base plate 30 and the gear plate 40 are laid on each other. The cover bracket 50 is combined to the base plate 30 and the gear plate 40 that are laid to each other. This configuration allows for pivotal movement of the base plate 30 and the gear plate 40 relative to each other. Meanwhile, the base plate 30 and the gear plate 40 are restrained from being moved in an axial direction relative to each other.

The axial direction here denotes a direction along the axis of the center shaft 22.

A cavity (space) C is created between the base plate 30 and the gear plate 40. As depicted in FIGS. 2 to 4, the cavity C contains a total of four locking gears, i.e., a pair of first locking gears 61 and a pair of second locking gears 62, a central cam 70, biasing members (two substantially arcuate spring members) 80, a substantially disk-shaped cam lever 90, and other members. These are members for bringing the reclining apparatus 20 into a locked or unlocked state. More specifically, these members constitute a gear mechanism of the reclining apparatus 20 for regulating engagement of the gear plate 40 with the base plate 30. In FIG. 2, the left side of the figure is referred to as a first side of the axial direction, and the right side of the figure is referred to as a second side of the axial direction.

The base plate 30 includes a side surface on the first side of the axial direction (hereinafter also referred to as a fitting surface 30a) and a side surface on the second side of the axial direction. A plurality of protuberances 30b is provided on the fitting surface 30a. These protuberances 30b are mated into mating holes (not shown) in the lower bracket 11a to fit the base plate 30 to the lower bracket 11a. As depicted in FIG. 3, four guide protrusions 31 and 32 for radially guiding the associated locking gears 61 and 62 are provided on the side surface on the second side of the axial direction of the base plate 30. More specifically, the first locking gears 61 are each guided by a pair of guide protrusions 31 and 32. Likewise, the second locking gears 62 are each guided by another pair of guide portions (guide protrusions 31 and 32.)

As depicted in FIG. 3, the guide protrusions (first guide portions) 31 each have a first guide surface 33a and a second guide surface 34b. Meanwhile, the guide protrusions (second guide portions) 32 each have a first guide surface 33b and a second guide surface 34a.

Specifically, the first locking gears 61 are guided by the first guide surfaces 33a of the guide protrusions 31 and the first guide surfaces 33b of the guide protrusions 32. The second locking gears 62 are guided by the second guide surfaces 34a of the guide protrusions 32 and the second guide surfaces 34b of the guide protrusions 31. Of the guide surfaces, recesses 35 are provided in the second guide surfaces 34b of the guide protrusions 31 to reduce the contact area with the second locking gears 62. The specific shape of the recesses 35 is described later.

On the inner peripheral surface of the gear plate 40 is provided a plurality of internal gears 41 along the entire circumference thereof and a plurality of arcuate step portions 42 that is coaxial with the entirely circumferential arrangement of the internal gears 41. A plurality of projections (not shown) is provided on the back surface of the gear plate 40 (a surface on the second side of the axial direction). The gear plate 40 is fitted to the upper bracket 12a by mating these projections into mating holes (not shown) in the upper bracket 12a.

In the example of FIG. 5, two arcuate step portions 42 are provided at intervals of 180 degrees on the inner peripheral surface of the gear plate 40. The arcuate step portions 42 have such a shape that achieves the above-mentioned lock-free state. More specifically, the arcuate step portions 42 are provided such that the angle range in which protuberances 61b (to be described later) on the first locking gears 61 are abuttable on the arcuate step portions 42 from the inner peripheral side corresponds to a predetermined freely pivotable range.

As depicted in FIG. 3, external gears 61a are provided along the outer peripheries of the first locking gears 61. External gears 62a are provided along the outer peripheries of the second locking gears 62. The external gears 61a and 62a are engageable with the internal gears 41 on the gear plate 40. The first locking gears 61 are guided by movable guides 36 (to be described later) that are guided by the first guide surfaces 33a of the guide protrusions 31 and the first guide surfaces 33b of the guide protrusion 32, so as to be supported in such a manner as to be slidable limitatively in the radial direction. The second locking gears 62 are guided by the second guide surfaces 34a of the guide protrusion 32 and the second guide surfaces 34b of the guide protrusions 31, so as to be supported in such a manner as to be slidable limitatively in the radial direction.

The first locking gears 61 are provided with the protuberances 61b. The protuberances 61b protrude to the second side of the axial direction (toward the gear plate.) The protuberances 61b abut on the arcuate step portions 42 from the inner peripheral side. Abutment of the protuberances 61b on the arcuate step portions 42 keeps the internal gears 41 and the external gears 61a out of engagement with one another. The second locking gears 62 are provided with protuberances 62b. The protuberances 62b protrude from the second side of the axial direction (toward the gear plate.) Further, the protuberances 62b are provided so as not to abut on the arcuate step portions 42.

Specifically, the protuberances 61b have a height that meets the following condition: When the protuberances 61b are inserted through cam openings 92 (to be described later), the tips of the protuberances 61b come proximate to a side surface of the gear plate 40. Meanwhile, the protuberances 62b have a height that meets the following condition: When the protuberances 62b are inserted through cam openings 93 (to be described later), the tips of the protuberances 62b do not protrude from the cam openings 93. In other words, the protuberances 61b have a greater height than the protuberances 62b.

The protuberances 61b are made abutted on the arcuate step portions 42 and the protuberances 62b are kept from abutting on the arcuate step portions 42 for the following reason: If the range of the angle at which the protuberances 61b and 62b abut on the arcuate step portions 42 corresponds to the above-described freely pivotable range, the arcuate step portions 42 will abut on the four protuberances (61b and 62b.) Hence, abutting portion of the arcuate step portions 42 are to be provided by four at intervals of 90 degrees. In such a case, a sufficient working angle is unable to be secured, as compared with the present disclosure (the intervals of 180 degrees.)

The movable guides 36 have a wedge shape with a width gradually reduced from a first end toward a second end thereof. The movable guides 36 are slidably arranged between the first locking gears 61 and the first guide surfaces 33b of the guide protrusions 32, respectively. The movable guides 36 have engaging holes 36a therein. The engaging holes 36a receive ends (first ends) of spring members (biasing members) 80 for biasing the movable guides 36 toward the interior of the base plate 30. With this structure, the movable guides 36 are jammed in between the first locking gears 61 and the first guide surfaces 33b of the guide protrusions 32 at all times. More specifically, these first locking gears 61, the first guide surfaces 33b of the guide protrusions 32, and the movable guides 36 fit one another snugly. In other words, substantially no gap is created between the members. Thus, play between the movable members is eliminated in the fore-and-aft direction of the seat back 12.

Description is given here of the shape of the recesses 35.

The recesses 35 are provided so as to substantially equate the contact area between the second guide surfaces 34b of the guide protrusions 31 and the second locking gears 62 to the contact area between the movable guides 36 and the first guide surfaces 33b of the guide protrusions 32. A reason therefor is given below.

For example, assume movable guides are provided to a portion of a plurality of locking gears. In such a case, the contact area is smaller between the movable guides and the guide surfaces for guiding the movable guides than between the locking gears dispensed with the movable guides and the guide surfaces for guiding the locking gears because of the presence of, for example, engaging portions to receive biasing members for biasing the movable guides toward the interior of the base plate. As a result, load imbalance may occur.

Therefore, of the pairs of second guide surfaces 34a and 34b, the recesses 35 are provided in the second guide surfaces 34b of the guide protrusions 31, which are pivotable in the same direction as the first guide surfaces 33b of the guide protrusions 32 relative to the first locking gears 61, as described above. This structure provides for reduction in difference between the contact area of the movable guides 36 with the first guide surfaces 33b of the guide protrusions 32 and the contact area of the second locking gears 62 with the second guide surfaces 34b of the guide protrusions 31.

The planar cam 70 is disposed pivotally at the center of the base plate 30. A through hole 71 is provided at the center of the cam. The cam 70 has a cam surface 72 along the outer peripheral surface thereof. The cam surface 72 abuts on the respective rear end surfaces of the locking gears 61 and 62. Two mating holes 73 and two columnar projections 74 are provided on a side surface of the cam. The mating holes 73 receive other ends (second ends) of the spring members 80. The projections 74 project to the second side of the axial direction.

As depicted in FIG. 4, the cam 70 is strongly biased in a locking pivotal direction (clockwise in FIGS. 3 and 4) by engagement with the second ends of the two spring members 80, which places the cam surface 72 of the cam 70 into abutment with the rear end surfaces of the locking gears 61 and 62. As a result, the locking gears 61 and 62 are strongly biased radially outward with the biasing force in the locking pivotal direction that is applied by the spring members 80.

The center shaft 22 is inserted through the through hole 71 in the cam 70. Turning the center shaft 22 allows the cam 70 to pivot in an unlocking pivotal direction (counter-clockwise in FIGS. 3 and 4) against the biasing force of the spring members 80.

As depicted in FIG. 4, the cam lever 90 has two through holes 91 to let the two projections 74 on the cam 70 pass therethrough, the two cam openings 92, and the two cam openings 93 therein. The projections 74 fit in the associated through holes 91. The protuberances 61b are passed through the associated cam openings 92. The protuberances 62b are passed through the associated cam openings 93. In this manner, the cam lever 90 is combined to the cam 70 and the locking gears 61 and 62.

In this structure, when the cam lever 90 pivots in the unlocking pivotal direction in conjunction with the cam 70, the inner peripheral edges of the two cam openings 92 abut on the associated protuberances 61b on the first locking gears 61, respectively. Further, the inner peripheral edges of the two cam openings 93 abut on the associated protuberances 62b on the second locking gears 62, respectively. Meanwhile, when the cam lever 90 pivots in the unlocking pivotal direction, these protuberances 61b and 62b are biased radially inward by the inner peripheral edges of the associated cam openings 92 and 93. This causes the locking gears 61 and 62 to move radially inward in conjunction with one another.

In the reclining apparatus 20 thus configured, a side peripheral portion of the base plate 30 and a side peripheral portion of the gear plate 40 are crimped by means of ring caulking with the cover bracket 50. More specifically, the base plate 30 and the gear plate 40 are integrated so as to provide the cavity C. The cavity C contains the locking gears 61 and 62, the cam 70, and other members therein. With this configuration, the base plate 30 and the gear plate 40 are maintained pivotable relative to each other and are restrained from moving in the axial direction relative to each other.

The reclining control lever 23 is combined to the center shaft 22 inserted through the through hole 71 in the cam 70. The reclining apparatus 20 as depicted in FIG. 2 is completed with this operation. The protuberances 30b on the base plate 30 of the reclining apparatus 20 thus configured are mated into the mating holes in the lower bracket 11a. Further, protuberances on the gear plate 40 are mated into the associated mating holes in the upper bracket 12a. In this manner, the seat cushion 11 and the seat back 12 are coupled to each other by means of the reclining apparatus 20 in a relatively inclinable manner. It is to be noted that the base plate 30 may also be fitted to the upper bracket 12a and the gear plate 40 may also be fitted to the lower bracket 11a.

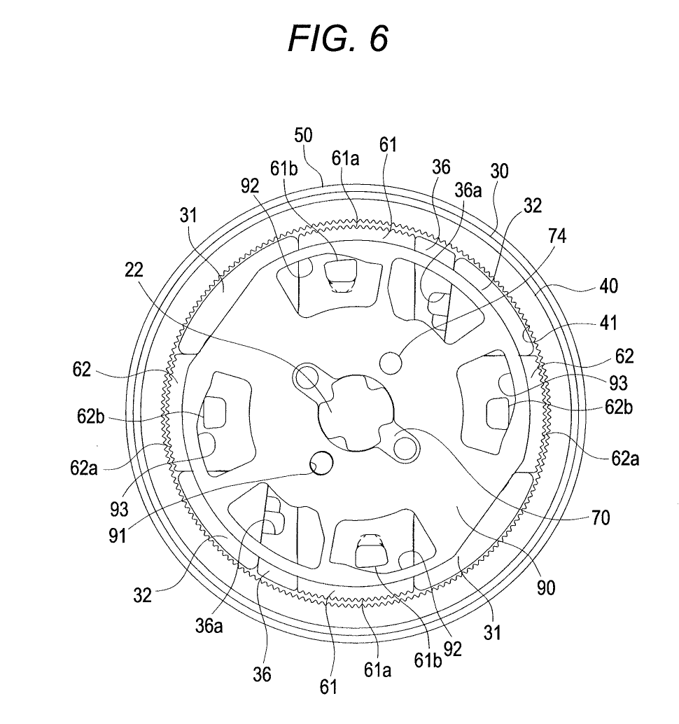

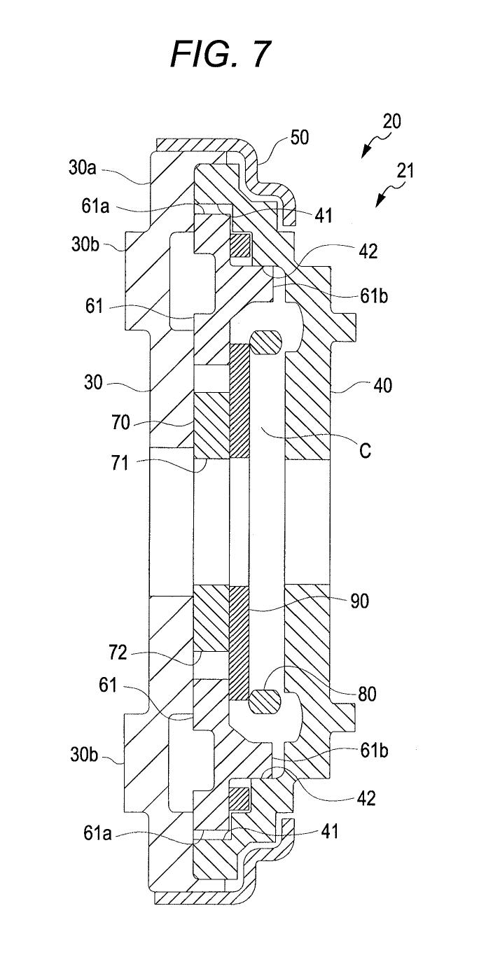

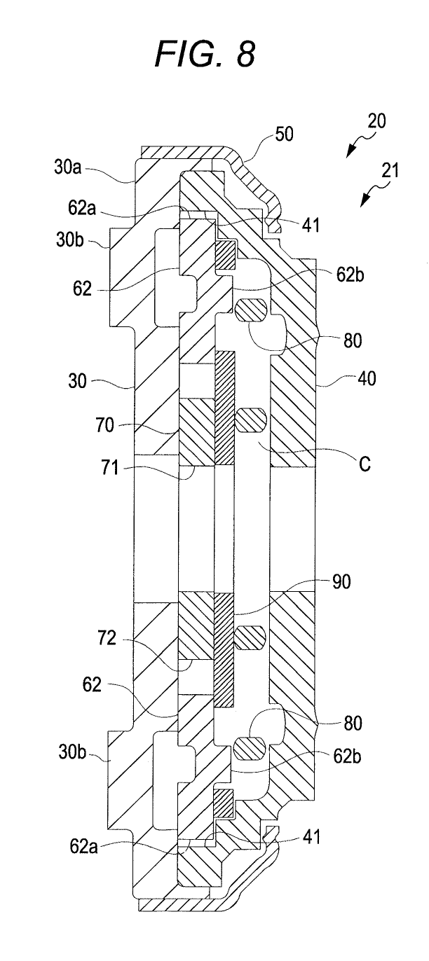

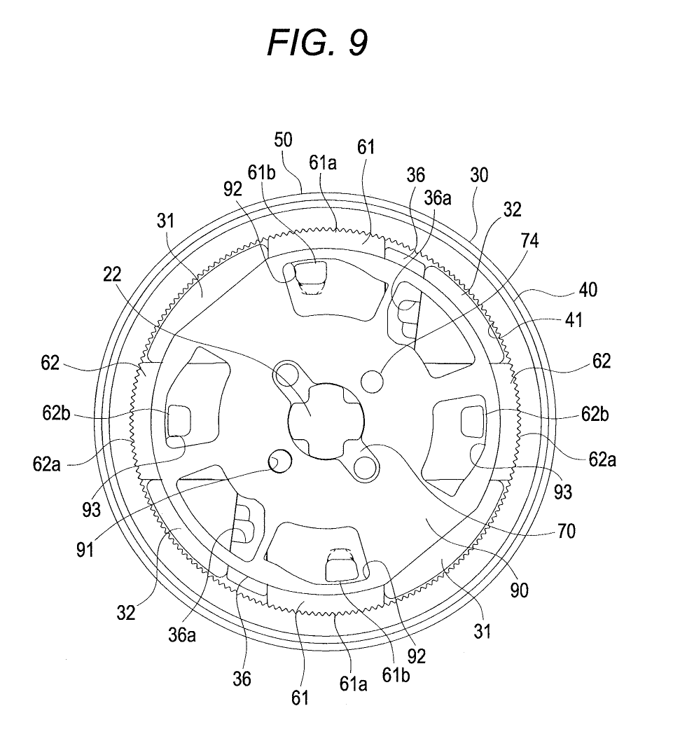

Description is given below of locked and unlocked states of the reclining apparatus 20 thus configured according to the present embodiment with reference to FIGS. 6 to 9. FIG. 6 is an explanatory view depicting a positional relationship between the locking gears 61 and 62 and the cam lever 90 in an unlocked state. FIG. 7 is a cross-sectional view depicting a state of abutment of the first locking gears 61 on the arcuate step portions 42 in a lock-free state. FIG. 8 is a cross-sectional view depicting the positions of the second locking gears 62 in the lock-free state. FIG. 9 is an explanatory view depicting a positional relationship between the locking gears 61 and 62 and the cam lever 90 in a locked state. FIGS. 6 to 9 each correspond to the cross section taken along line 4-4 in FIG. 2. In FIGS. 6 and 9, the spring members 80 depicted in FIG. 4 are not shown for easy understanding.

### Unlocked State

The unlocked state of the reclining apparatus 20 is described first.

If the user wants to adjust the inclination of the seat back 12, he/she unlocks the reclining apparatus 20. In doing so, the user operates the reclining control lever 23 to turn the center shaft 22 in the unlocking pivotal direction. As a result, the cam 70 pivots in the unlocking pivotal direction together with the center shaft 22 against the biasing force of the spring members 80.

The pivotal movement of the cam 70 in the unlocking pivotal direction brings the cam surface 72 of the cam 70 out of abutment on the rear end surfaces of the locking gears 61 and 62. Thus, the biasing force applied by the cam 70, which biases the locking gears 61 and 62 radially outward, disappears. In this manner, the locking gears 61 and 62 are allowed to move radially inward. Hence, a state is achieved in which the internal gears 41 on the gear plate 40 are releasable from engagement with the external gears 61a and 62a on the locking gears 61 and 62.

The cam lever 90 then pivots in the unlocking pivotal direction together with the cam 70. Then, as depicted in FIG. 6, the inner peripheral edges of the cam openings 92 and 93 in the cam lever 90 abut on the associated protuberances 61b and 62b on the locking gears 61 and 62, so as to cause the locking gears 61 and 62 to move radially inward. As a result, the internal gears 41 are released from the engagement with the external gears 61a and 62a.

As described above, upon release of mesh between the internal gears 41 and the external gears 61a and 62a, the gear plate 40 becomes freely pivotable. Thus, the round reclining unit 21 comes into an unlocked state. The unlocked state of the round reclining unit 21 turns the reclining apparatus 20 into an unlocked state. Hence, for inclining the seat back 12 toward the aft, the user can freely adjust the inclination of the seat back 12 (see the angle A in FIG. 1.)

### Lock-Free State

Description is given next of a lock-free state of the reclining apparatus 20.

In the above-described unlocked state, the base plate 30 and the gear plate 40 pivot relative to each other to allow the seat back 12 to be inclined toward the fore. As a result, the first locking gears 61 are moved to a position at which the protuberances 61b are abuttable on the arcuate step portions 42 of the gear plate 40. The reclining control lever 23 is loosened in this state to allow the cam 70 to pivot in the locking pivotal direction by the biasing force of the spring members 8. The pivotal movement of the cam 70 causes the locking gears 61 and 62 to be biased radially outward.

As depicted in FIG. 7, the protuberances 61b on the first locking gears 61 abut on the arcuate step portions 42. Thus, the internal gears 41 and the external gears 61a and 62a are kept out of engagement with one another. In this case, as depicted in FIG. 8, the protuberances 62b on the second locking gears 61 do not abut on the arcuate step portions 42. Thus, during abutment of the protuberances 61b on the arcuate step portions 42, the unlocked state is maintained even when the seat back 12 is inclined toward the fore to allow the base plate 30 and the gear plate 40 to pivot relative to each other (see the angle B in FIG. 1.)

### Locked State

Description is given next of the locked state of the reclining apparatus 20.

Upon completion of adjustment of the inclination of the seat back 12, the user locks the reclining apparatus 20. In doing so, the user loosens the reclining control lever 23. This causes the cam 70 to pivot in a locking pivotal direction with the biasing force of the spring members 80.

The cam surface 72 of the cam 70 pivoting abuts on the rear end surfaces of the locking gears 61 and 62. This causes the locking gears 61 and 62 to be biased radially outward. In this manner, the external gears 61a on the locking gears 61 and the external gears 62a on the locking gears 62 are moved radially outward to engage with the internal gears 41 on the gear plate 40.

Then, as depicted in FIG. 9, the external gears 61a on the locking gears 61 and the external gears 62a on the locking gears 62 engage with the internal gears 41 on the gear plate 40, such that the pivoting of the gear plate 40 is restricted. As a result, the reclining apparatus 20 is latched in a locked state.

As has been described above, the reclining apparatus 20 according to the present embodiment, of the pairs of the second guide surfaces, the recesses 35 are provided in the second guide surfaces 34b of the guide protrusions 31 that pivot in the same direction as the first guide surfaces 33b of the guide protrusions 32 relative to the first locking gears 61, so as to reduce a contact area between the second locking gears 62 and the second guide surfaces 34b.

This structure provides for reduction in difference between the contact area of the movable guides 36 with the first guide surfaces 33b of the guide protrusions 32 and the contact area of the second locking gears 62 with the second guide surfaces 34b of the guide protrusions 31.

Hence, imbalance in load to act on the locking gears 61 and 62 is suppressed even in the case where the movable guides 36 are employed for a portion of the locking gears (first locking gears 61).

It is to be noted that the recesses 35 are provided in the second guide surfaces 34b so as to substantially equate the contact area between the second guide surfaces 34b of the guide protrusions 31 and the second locking gears 62 to the contact area between the movable guides 36 and the first guide surfaces 33b of the guide protrusions 32. Therefore, imbalance in load to act on the locking gears 61 and 62 is reliably suppressed.

The present disclosure is not limited to the foregoing embodiment. For example, the present disclosure may be embodied also as described below.

(1) As described above, the recesses 35 are provided in the second guide surfaces 34b so as to substantially equate the contact area between the second guide surfaces 34b of the guide protrusions 31 and the second locking gears 62 to the contact area between the movable guides 36 and the first guide surfaces 33b of the guide protrusions 32. However, this is not limitative. The recesses 35 may be provided in such a manner that difference in the contact areas is reduced.

(2) The number of the locking gears to be guided by the guide protrusions 31 and 32 on the base plate 30 is not limited to four (two first locking gears 61 and two second locking gears 62.) For example, the number of the locking gears may be three, or may be five or more. In this case, a portion of the locking gears is arranged so as to be guided by the movable guides 36 and the first guide surfaces 33a of the guide protrusions 31. Meanwhile, the remaining locking gears are arranged so as to be guided by the second guide surfaces 34a of the guide protrusions 32 and the second guide surfaces 34b having the recesses 35 of the guide protrusions 31. Also in this manner, imbalance in load to be applied to the locking gears is reliably suppressed.

The reclining apparatus according to the present embodiment may also be represented as the following first and second reclining apparatuses. That is, a first reclining apparatus is configured to adjust the inclination between a first member and a second member that are inclinable relative to each other. The first reclining apparatus includes: a base plate attached to the first member; a gear plate attached to the second member and combined so as to be pivotable relative to the base plate, the gear plate having internal gears; a first locking gear having external gears engageable with the internal gears, the first locking gear being combined so as to be slidably guided in a radial direction in contact with one of a pair of first guide surfaces provided on the base plate; a second locking gear having external gears engageable with the internal gears, the second locking gear being combined so as to be slidably guided in a radial direction in contact with both of a pair of second guide surfaces provided on the base plate; a movable guide disposed to be slidable to the other of the pair of first guide surfaces and to the first locking gear, and to be biased toward the interior of the base plate, the movable guide having a gradually reducing width from the outer end toward the inner end thereof; a cam for regulating movement of the first locking gear and the second locking gear in a radially outward direction to bring the external gears into engagement with the internal gears; a biasing member for rotatingly biasing the cam in a direction in which the external gears are caused to engagement with the internal gear; and a release member configured to rotatingly drive the cam against the biasing force of the biasing member to release engagement between the external gears and the internal gears. Of the pair of second guide surfaces, a recess is provided in the second guide surface that orients the same pivotal direction as the other of the first guide surfaces that faces the first locking gear, so as to reduce a contact area with the second locking gear.

In a second reclining apparatus according to the first reclining apparatus, the recess is provided so as to substantially equate the contact area between the second guide surface having the recess and the second locking gear to the contact area between the movable guide and the other of the first guide surfaces.

In the first reclining apparatus, of the pair of second guide surfaces, a recess is provided in the second guide surface that orients the same pivotal direction as the other of the first guide surfaces that faces the first locking gear, so as to reduce a contact area with the second locking gear.

Assume a movable guide is provided for a portion of a plurality of locking gears. In such a case, the contact area between the movable guide and a guide surface for guiding the movable guide is smaller than the contact area between a locking gear dispensed with the movable guide and a guide surface for guiding the locking gear, for the presence of, for example, an engaging portion to receive a biasing member for biasing the movable guide toward the interior of the base plate. As a result, load imbalance as describes above will occur.

Therefore, of the pair of second guide surfaces, a recess is provided in the second guide surface that orients the same pivotal direction as the other of the first guide surfaces that faces the first locking gear. This structure provides for reduction in difference between the contact area of the movable guide with the other of the first guide surfaces and the contact area of the second locking gear with the second guide surface.

Thus, imbalance in load to be applied to the locking gears is suppressed even in the case of employing a movable guide for a portion of locking gears.

In the second reclining apparatus, the recess is provided so as to substantially equate the contact area between the second guide surface having the recess and the second locking gear to the contact area between the movable guide and the other of the first guide surfaces. Thus, imbalance in load to act on the locking gears is reliably suppressed.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A reclining apparatus for adjusting the inclination between a first member and a second member that are inclinable relative to each other, the reclining apparatus comprising:
a base plate attached to the first member;
a gear plate attached to the second member and combined to the base plate in such a manner as to be pivotable relative to the base plate;
a first guide portion and a second guide portion that are provided on the base plate;
a first guide surface and a second guide surface that are provided on the first guide portion;
a first guide surface and a second guide surface that are provided on the second guide portion;
a first locking gear and a second locking gear that are engageable with the gear plate; and
a movable guide interposed between the first guide portion or the second guide portion and the first locking gear or the second locking gear, wherein
the first guide surface of the second guide portion faces the first locking gear, and
a recess is provided in the second guide surface of the first guide portion that orients the same pivotal direction as the first guide surface of the second guide portion to reduce a contact area with the second locking gear.

2. The reclining apparatus according to claim 1, wherein
the gear plate has internal gears,
the first locking gear has external gears engageable with the internal gears, the first locking gear being configured to be slidably guided in a radial direction in contact with the first guide surface of the first guide portion, and
the second locking gear has external gears engageable with the internal gears, the second locking gear being configured to be slidably guided in a radial direction in contact with the second guide surface of the first guide portion and with the second guide surface of the second guide portion.

3. The reclining apparatus according to claim 1, wherein
the movable guide is slidable toward the first guide surface of the second guide portion and toward the first locking gear,
the movable guide is disposed in such a manner as to be biased toward the interior of the base plate, and
the movable guide has, from an outer end toward an inner end thereof, a gradually reducing width.

4. The reclining apparatus according to claim 1, further comprising:
a cam for regulating movement of the first locking gear and the second locking gear in a radially outward direction to cause the external gears to engage with the internal gears;
a biasing member for rotatingly biasing the cam in a direction in which the external gears are caused to engage with the internal gears; and
a release member configured to rotatingly drive the cam against the biasing force of the biasing member in such a manner as to release the mesh between the external gears and the internal gears.

5. The reclining apparatus according to claim 1, wherein
the recess is provided in such a manner as to substantially equate the contact area between the second guide surface having the recess and the second locking gear to the contact area between the movable guide and the first guide surface of the second guide portion.

6. The reclining apparatus according to claim 1, wherein the biasing member is a spring member.
